(19) United States
(12) Patent Application Publication
(10) Pub. No.: US 2019/0247840 A1
(43) Pub. Date: Aug. 15, 2019

(54) PHOTOCATALYST COMPOSITION

(71) Applicant: Jason YAN, New Taipei City (TW)

(72) Inventors: Jason YAN, New Taipei City (TW); Wen-Lung KAN, New Taipei City (TW)

(21) Appl. No.: 16/001,475

(22) Filed: Jun. 6, 2018

(30) Foreign Application Priority Data
Feb. 9, 2018 (TW) 107104648

(51) Int. Cl. B01J 35/00; B01J 21/06; B01J 21/18; B01J 37/08; B01J 37/02; B01D 53/86

(52) U.S. Cl. CPC B01J 35/004; B01J 21/063; B01J 21/18; B01J 37/08; B01D 2257/708; B01D 53/8668; B01D 2255/802; B01D 2255/20707; B01D 2255/702; B01J 37/0215

(57) ABSTRACT

A photocatalyst composition and an air filtration structure with the photocatalyst composition are provided. The air filtration structure is characteristic of the photocatalyst composition uniformly distributed on a substrate and comprises graphene as carriers, titanium dioxide with a nano-level particle sizes for structural modification, and refractive and reflective photoconductive materials by which titanium dioxide is irradiated by more ultraviolet or blue light to improve the air purification ability of the photocatalyst composition.

This application claims priority to the Taiwanese Patent Application No. 107104648 filed on Feb. 9, 2018, and which is herein incorporated by reference in its entirety.

### BACKGROUND OF THE INVENTION

### 1. Field of the Invention

The present disclosure relates to a photocatalyst composition, and more particularly to a photocatalyst composition used in an air filter.

### 2. Description of the Prior Art

Various air pollution sources that permeate in our daily lives can be divided into outdoor exhaust gases from industrial sources, transportation, volatile organic compounds, toxic gases from household furniture, or construction materials such as indoor wood floors and brick wall paints with free formaldehyde possibly, which can be discomforting during a long-term exposure or contact and even give rise to various symptoms including pricking, drying, allergy and inflammation or increase the risk of cancer. Currently, the indoor air quality has been improved mostly by installation of air cleaners.

The existing air cleaners mostly use motor to import, for example, foul air, bacteria, smell of smoke and stale odor, and then use the combination of ultraviolet light and photocatalyst (TiO₂) to achieve the effect of air purification.

However, it is known that particle sizes of the photocatalyst in the existing air cleaners range between 20˜250 nm. The specific surface area of these photocatalyst particles is large and thus the effect of air purification is limited.

Improving the above deficiency is the technical problem to be solved by the present inventor.

### SUMMARY OF THE INVENTION

It is therefore an object of this disclosure to provide, a photocatalyst composition.

The photocatalyst composition of the present invention comprises titanium dioxide, graphene and photoconductive materials, wherein the photoconductive materials can be silicon dioxide, quartz, glass, photoconductive plastics or photoconductive minerals. The weight percentages of titanium dioxide, graphene and photoconductive materials in the photocatalyst composition are 60˜70%, 15˜20% and 15˜20%, respectively.

Further, the invention provides an air filtration structure made of the photocatalyst composition and a substrate, wherein the photocatalyst composition is deposited on the substrate surface via the process of sintering, coating or the combination of the two. The substrate has a reticular structure which is made of flannelette, sponges, metals, polymers, composite materials or stainless steels.

The photocatalyst composition is made of graphene as carriers and uses titanium dioxide for structural modification to maintain the particle sizes of titanium dioxide below 10 nm or preferably below 7 nm. In addition, the light refraction and reflection characteristics of the photoconductive materials will be used to irradiate more ultraviolet or blue light to titanium dioxide, so as to improve the air purification ability of the photocatalyst composition.

### BRIEF DESCRIPTION OF THE DRAWINGS

FIG. 1 is a schematic diagram of an air filtration structure of the invention.

FIG. 2 is a schematic diagram of the profile of a photocatalyst composition of the invention irradiated by ultraviolet light.

### DETAILED DESCRIPTION OF THE PREFERRED EMBODIMENT

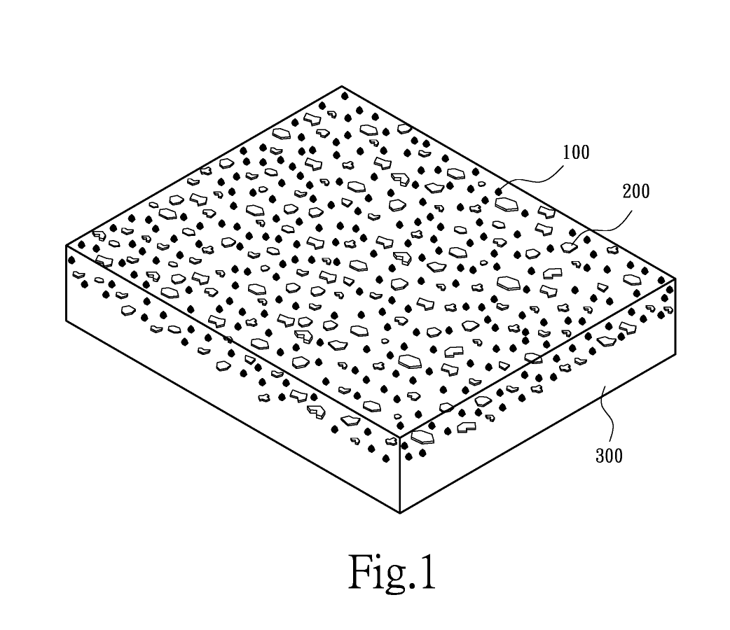

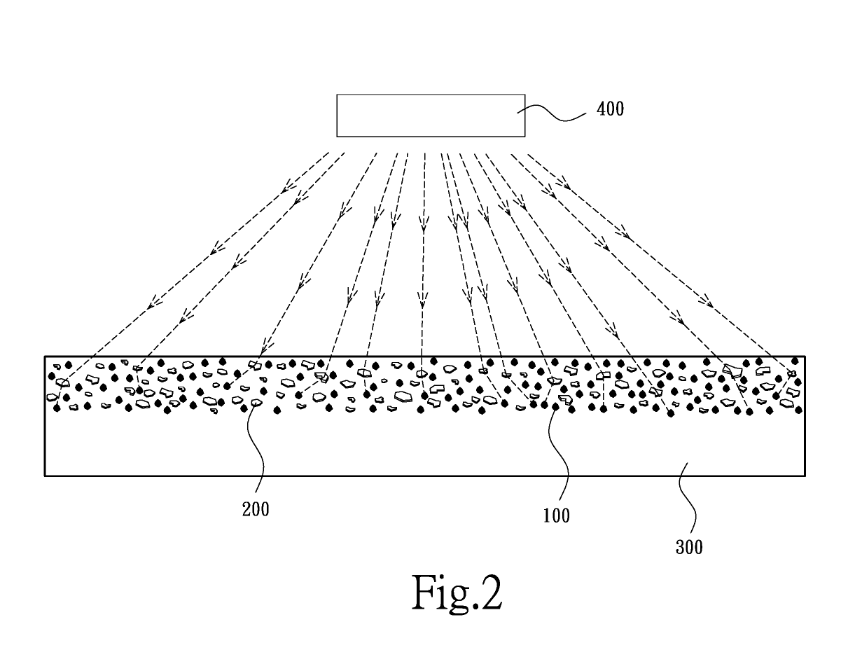

Referring to FIG. 1, an air filtration structure mainly comprises compounds 100 with graphene-based carriers and titanium dioxide for structural modification, photoconductive materials 200 and a substrate 300. The photoconductive materials 200 are silicon dioxide, quartz, glass, photoconductive plastics or photoconductive minerals and the substrate 300 has a reticular structure made of flannelette, sponges, metals, polymers, composite materials or stainless steels. As shown in the figures, a photocatalyst composition in the present disclosure comprises compounds 100 and photoconductive materials 200, both of which are uniformly distributed on the substrate 300. FIG. 2 illustrates a schematic diagram of the profile of the photocatalyst composition that is irradiated by ultraviolet (UV) light 400. After ultraviolet light 400 irradiation of the surface of the substrate 300, in addition to irradiation of the compounds 100 directly through the substrate 300, ultraviolet (UV) light 400is also partially reflected or refracted to the compounds 100 by the photoconductive materials 200 thereby effecting the purification of the air.

The graphene of the compounds 100 forms covalent bonds that break 7E bonds in graphitic layers with strong oxidizers and Van der Waals forces are further dissociated under external forces. Then, the compounds 100 are produced when the oxidized graphene is modified with titanium dioxide. After mixing the compounds 100 and the photoconductive materials 200 according to a specific proportion, a medium (solid, liquid or colloid) of the photocatalyst composition is dispensed or distributed on the substrate 300 surface via the processes of sintering, baking and/or drying.

The photocatalyst composition and the air filtration structure of the present invention are stimulated by the photocatalytic composition through ultraviolet wavelengths of less than 400 nm, or specific ultraviolet wavelengths of 365 nm or 254 nm, or blue light. When ultraviolet or blue light is irradiated on the photocatalyst composition that is distributed on the substrate surface, electron-hole pairs are generated from the compounds featuring graphene as carriers and titanium dioxide for structural modification. The electron-hole pairs further react with oxygen and moisture in air for generation of hydroxyl radicals (OH) by which airborne organics, inorganic substances, odor, bacteria, viruses, and the like are decomposed for the effective air purification.

While the preferred embodiment of the invention has been set forth for the purpose of disclosure, it should not be the limitations of the invention, modifications of the disclosed embodiment of the invention as well as other embodiments thereof may occur to those skilled in the art. Accordingly, the appended claims are intended to cover all embodiments which do not depart from the spirit and scope of the invention.

1. A photocatalyst composition, comprising titanium dioxide, graphene and photoconductive materials; wherein the weight percentages of titanium dioxide, graphene and photoconductive materials are 60˜70%, 15˜20% and 15˜20%, respectively.

2. The photocatalyst composition as claimed in claim 1 wherein the photoconductive materials can be silicon dioxide.

3. The photocatalyst composition as claimed in claim 1 wherein the photoconductive materials can be quartz, glass, photoconductive plastics or photoconductive minerals.

4. An air filtration structure, comprising a photocatalyst composition and a substrate,
wherein the photocatalyst composition comprises titanium dioxide, graphene and photoconductive materials; wherein the weight percentages of titanium dioxide, graphene and photoconductive materials are 60˜70%, 15˜20% and 15˜20%, respectively,
wherein the particle sizes of titanium dioxide is below 10 nm, and
wherein the photoconductive materials irradiate ultraviolet or blue light to titanium dioxide to improve air purification effect.

5. The air filtration structure as claimed in claim 4 wherein the photocatalyst composition is deposited on the substrate surface.

6. The air filtration structure as claimed in claim 4 wherein the substrate has a reticular structure.

7. The air filtration structure as claimed in claim 4 wherein the substrate is made of flannelette, sponges, metals, polymers or composite materials.

8. The air filtration structure as claimed in claim 6 wherein the substrate is made of stainless steels.

9. The air filtration structure as claimed in claim 4 wherein the photocatalyst composition is deposited on the substrate surface via a process of sintering.

10. The air filtration structure as claimed in claim 4 wherein the photocatalyst composition is deposited on the substrate surface via a process of coating.

11. The air filtration structure as claimed in claim 4, wherein the particle sizes of titanium dioxide is below 7 nm.
